(19) United States
(12) Patent Application Publication
(10) Pub. No.: US 2008/0100514 A1
(43) Pub. Date: May 1, 2008

(54) Antenna Arrangement for Hinged Wireless Communication Device

(76) Inventors: Mohammed R. Abdul-Gaffoor, Palatine, IL (US); Faisal Abedin, Lindenhurst, IL (US); Prashant B. Patel, Grayslake, IL (US)

Correspondence Address: WHYTE HIRSCHBOECK DUDEK S C, 555 EAST WELLS STREET, SUITE 1900, MILWAUKEE, WI, 53202, US

(21) Appl. No.: 11/552,596

(22) Filed: Oct. 25, 2006

(51) Int. Cl. H01Q 1/24

(52) U.S. Cl. 343/702

(57) ABSTRACT

An improved wireless communication device, such as a clamshell-type cellular telephone, and related method of operation are disclosed. In at least some embodiments, the wireless communication device includes a first structure and a second structure that is hingedly coupled to the first structure, where at least a part of at least one of the first and second structures is capable of operating as an antenna. The device further includes an electrical circuit at least partially governing operation of the antenna, where the electrical circuit is supported at least indirectly by at least one of the first and second structures. At least one electrical characteristic of the electrical circuit varies depending upon a relative positioning of the first structure with respect to the second structure.

### FIELD OF THE INVENTION

The present invention relates to devices that employ antennas, and more particularly relates to devices that are capable of wireless communications, for example, cellular telephones.

### BACKGROUND OF THE INVENTION

Wireless communication devices such as cellular telephones, pagers, personal digital assistants, other handheld devices, laptop/notebook personal computers, and other devices are ubiquitous in the modern world. There continues to be an incentive to design these wireless communication devices so that the devices are smaller and more lightweight, so as to improve their portability as well as to achieve other goals (e.g., to reduce power consumption). Notwithstanding the desire for size reductions, it is also desired that the devices be capable of more and more functions and applications (e.g., UPS, WiFi, WiMAX, Bluetooth, Diversity, MediaFLO, DVB-H, etc.). Consequently, the increasingly limited physical volume or “real estate” available within such devices is becoming increasingly valuable, and there is great incentive to redesign component parts to occupy less physical volume.

To enable or at least facilitate wireless communications, wireless communication devices typically include one or more antennas or antenna structures. Further, to achieve a desired level of performance, a given antenna typically must be of an appropriate physical size. As a result, it is often particularly difficult to reduce the volume occupied by an antenna in a wireless communication device and still achieve a desired level of performance, and the need for antennas in wireless communication devices such as cellular telephones can present an impediment to further reducing the overall sizes of the devices. Additionally, while in many conventional wireless communication devices this problem is addressed by providing antennas that extend outward from the main bodies of the devices rather than being primarily contained within the perimeters of the main bodies of the devices, wireless communication devices configured in this manner can be somewhat unwieldy or lack robustness (e.g., because the antennas may be broken off).

For at least these reasons, therefore, it would be advantageous if an improved antenna configuration could be achieved for implementation in wireless communication devices such as cellular telephones. More particularly, it would be advantageous if such an improved antenna configuration provided a desired level of performance and yet at the same time did not require as much dedicated physical space within the wireless communication device as would be required by a conventional antenna configuration capable of providing a similar level of performance. Preferably (albeit not necessarily), the improved antenna configuration would also not require the use of any antenna structure that substantially extended outside of the perimeter of the main body of the given wireless communication device.

### BRIEF SUMMARY OF THE INVENTION

The present inventors have recognized that the metallic outer housings or other metallic structures of many wireless communication devices such as cellular telephones can serve as antennas, and thus that it is possible to substantially reduce if not completely eliminate the volumes dedicated to antennas within such devices by utilizing these metallic structures as the antennas (or as portions of the antennas) of the devices. That is, by utilizing, as antennas, metallic structures that conventionally have served only purposes unrelated to those served by antennas, much if not all of the volume within wireless communication devices that might conventionally have been occupied by conventional antennas is now freed up for other uses, and/or the overall volume of the wireless communication devices can be correspondingly shrunk.

Further, the present inventors have recognized that many wireless communication devices having hinged structures such as clamshell-type cellular telephones can in at least some embodiments be designed to achieve dual-mode antenna configurations. Such a dual-mode device operates in a first mode when the device is closed and in a second mode when the device is opened, the mode of operation being switched by the normal mechanical opening and closing of the device. In at least some such embodiments, the opening and closing actions switch on and off different electrical matching circuits appropriate for the different operational modes, or vary capacitances (or other electrical characteristics) so as to vary antenna operation in appropriate manners suited to the open or closed positioning of the device.

In at least some embodiments, the present invention relates to a wireless communication device that includes a first structure and a second structure that is hingedly coupled to the first structure, where at least a part of at least one of the first and second structures is capable of operating as an antenna. The device further includes an electrical circuit at least partially governing operation of the antenna, where the electrical circuit is supported at least indirectly by at least one of the first and second structures. At least one electrical characteristic of the electrical circuit varies depending upon a relative positioning of the first structure with respect to the second structure.

Additionally, in at least some embodiments, the present invention relates to a cellular telephone that includes a top housing portion and a bottom housing portion, where at least one of the top and bottom housing portions operates as an antenna. The telephone also includes an electrical circuit coupled to the antenna, and means for rotatably coupling the top and bottom housing portions. An electrical characteristic of the electrical circuit varies based upon a change in a relative positioning of the top and bottom housing portions.

Further, in at least some embodiments, the present invention relates to a method of operating a wireless communication device. The method includes providing first and second structures that are hingedly coupled to one another, and operating the device in a first mode, where first communication via a first antenna of the device is governed by an electrical circuit having an electrical characteristic. The method additionally includes varying a first position of the first structure in relation to a second position of the second structure, where the varying results in a change in the electrical characteristic of the electrical circuit, and operating the device in a second mode, where second communication via at least one of the first antenna and a second antenna of the device is governed by the electrical circuit having the changed electrical characteristic.

### BRIEF DESCRIPTION OF THE DRAWINGS

FIGS. 1A and 1B respectively are schematic illustrations of an exemplary wireless communication device in open and closed positions, respectively, along with corresponding electrical circuit schematic diagrams representative of first and second antenna circuits that are respectively achieved when the device is in the open and closed positions, in accordance with at least some embodiments of the present invention;

FIGS. 2A and 2B respectively are simplified side-elevation views of another exemplary wireless communication device in open and closed positions, respectively, shown in partial cutaway, along with corresponding electrical circuit schematic diagrams representative of first and second antenna circuits that are respectively achieved when the device is in the open and closed positions, in accordance with at least some embodiments of the present invention;

FIGS. 2C and 2D are simplified perspective, partially cutaway views of the device of FIGS. 2A and 2B that are intended to particularly show the hinge area of the device when the device is in open and closed positions, respectively;

FIG. 3 is a block diagram showing exemplary internal components of a wireless communication device such as that shown in FIGS. 1A, 1B, 2A and 2B;

FIGS. 4A and 4B respectively show simplified perspective views of additional exemplary wireless communication devices that respectively employ inductive and capacitive ground coupling between upper and lower flip structures of the devices; and

FIGS. 5A and 5B respectively show simplified perspective views of additional wireless communication devices similar to those described with respect to the other FIGS., except insofar as these devices include additional conventional antennas on their lower and upper flip sections, respectively.

### DETAILED DESCRIPTION OF THE INVENTION

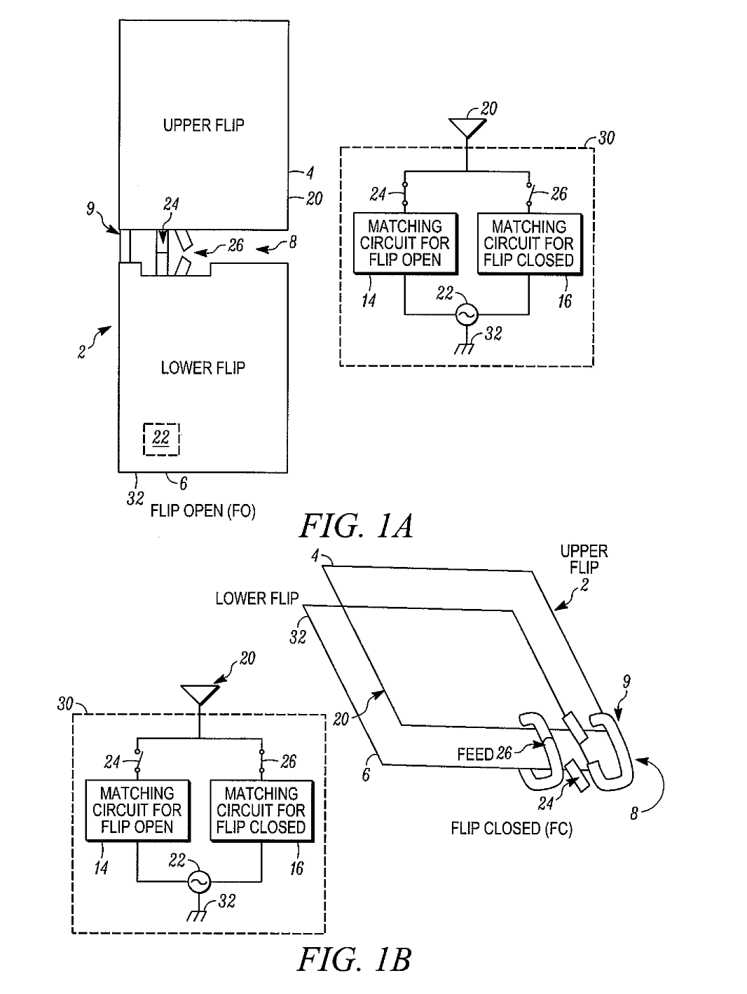

Referring to FIGS. 1A and 1B, an exemplary wireless communication device is shown that in the present embodiment, is a cellular telephone 2. Further as shown, the cellular telephone 2 is a clamshell-type phone having an upper flip section 4 and a lower flip section 6 that are coupled together in a hinged or rotatable manner by way of a hinge or similar mechanism, which in the present embodiment is shown as a hinge 8. The hinge 8 is capable of not only securing the flip sections 4, 6 together in a hinged or rotatable manner, but also is capable of serving as a channel (or multiple channels) through which wires or other connections can pass between the flip sections, allowing for the communication of signals, information and/or power between the flip sections and also serving as a ground connection between the flip sections. In FIGS. 1A and 1B such channels within the hinge 8 are represented by flex connections 9.

More particularly, FIG. 1A shows the cellular telephone 2 to be in an open position such that the upper flip section 4 and lower flip section 6 generally extend away from the hinge 8 and extend away from one another. When in such an open position, the upper and lower flip sections 4, 6 need not be exactly diametrically opposed such that the flip sections form a 180° angle between them (assuming the hinge as the vertex). Rather, the upper and lower flip sections 4, 6 when in the open position can be positioned so as to extend substantially away from one another, for example, such that the flip sections form an angle of approximately 160° to 175° between them. In contrast to FIG. 1A, FIG. 1B shows the cellular telephone 2 to be in a closed position such that the upper flip section 4 and the lower flip section 6 are positioned so as to extend alongside one another or adjacent to one another in the same direction away from the hinge 8 (or substantially adjacent, such that no more than a 15° angle is formed between the sections).

Typically, the cellular telephone 2 will have a length of approximately 80 to 200 mm when open and approximately 40 to 100 mm when closed. In the present embodiment, the lower flip section 6 of the cellular telephone 2 can be considered to be the mouthpiece of the phone while the upper flip section 4 can be considered to be the earpiece of the phone, albeit in other embodiments the roles could be reversed. The use of the terms “upper” and “lower” in describing the flip sections 4, 6 are being used for convenience herein and should not be interpreted as requiring any particular arrangement of the sections with reference to the ground or otherwise.

In the present embodiment, a metallic (typically outer) housing portion of the upper flip section 4 serves not only in a physical structural (e.g., supportive or protective) capacity but also serves as or includes an antenna 20. The lower flip section 6 in the present embodiment, while not including any antenna, is the section of the cellular telephone 2 in which is located a transceiver 22 (see FIG. 1A in particular). A metallic (typically outer) housing portion of the lower flip section 6 also can serve as a ground 32 for the transceiver 22 (thus, by virtue of the connections established between the upper and lower flip sections 4,6 by way of the hinge 8, the antenna in the upper flip section can be coupled to the ground in the lower flip section). In alternate embodiments, the antenna could be positioned on the lower flip section 6, or on both of the upper flip section 4 and the lower flip section.

The characteristics and operation of the antenna 20 within the cellular telephone 2 naturally vary as the telephone switches between its open or closed position. To compensate for these variations and achieve desired antenna operation regardless of whether the cellular telephone 2 is open or closed, in the present embodiment, the effective operation of the antenna 20 is modified depending upon the relative positioning of the upper and lower flip sections 4, 6 by equipping the cellular telephone with special transceiver circuitry 30, as shown additionally in electrical schematic form in FIGS. 1A and 1B. As shown, the transceiver circuitry 30 includes not only the transceiver 22 itself, but also includes first and second matching circuits 14 and 16, respectively, and first and second contacts 24 and 26, respectively.

More particularly, the transceiver 22 is coupled between the ground 32 and each of the respective matching circuits 14, 16. The first and second matching circuits 14 and 16 in turn respectively are coupled in series between the transceiver 22 and the antenna 20 (which again is, or is comprised within, the metallic housing portion of the upper flip section that also serves in a structural capacity), by way of the first and second contacts 24 and 26, respectively. As also shown in FIGS. 1A and 1B, the first and second contacts 24, 26 in the present embodiment are positioned in between the upper and lower flip sections 4 and 6, and can be considered to be part of the hinge 8, while the matching circuits 14, 16 are mounted on the lower flip section 6 along with the transceiver 22. The contacts 24, 26 are actuated depending upon the relative positioning of the upper flip section 4 relative to the lower flip section 6. In alternate embodiments, other physical arrangements are possible, for example, the matching circuits can also be formed as part of the hinge 8 along with the contacts 24, 26.

Further as shown, the antenna 20 of the cellular telephone 2 is capable of being coupled to the transceiver 22 by way of either of the first and second matching circuits 14, 16 depending upon whether the contacts 24, 26 are open or closed, but the antenna is only coupled to one of those matching circuits at any given time. More particularly, as shown in FIG. 1A, when the cellular telephone 2 is in the open state, the first contact 24 is closed while the second contact 26 is open, and consequently the antenna 20 is coupled to the transceiver 22 by way of the first matching circuit 14 but not the second matching circuit 16. However, when the cellular telephone 2 is in the closed position, the first contact 24 is open and the second contact 26 is closed, such that the antenna 20 is coupled to the transceiver 22 by way of the second matching circuit 16 but not the first matching circuit 14. Thus, manual opening and closing of the cellular telephone 2 automatically switches a matching characteristic of the circuitry 30 such that desired antenna operation is achieved regardless of whether the cellular telephone is open or closed.

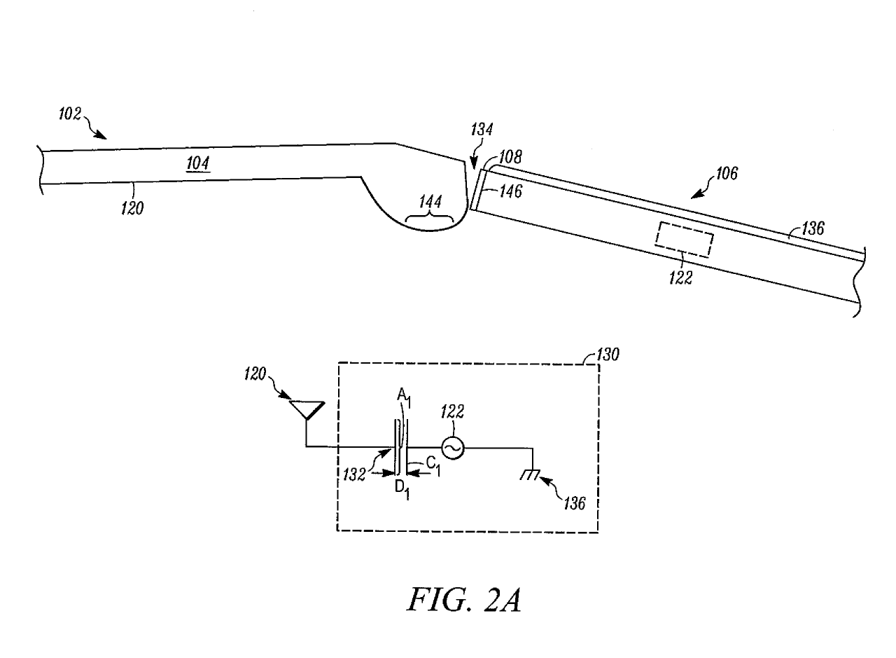

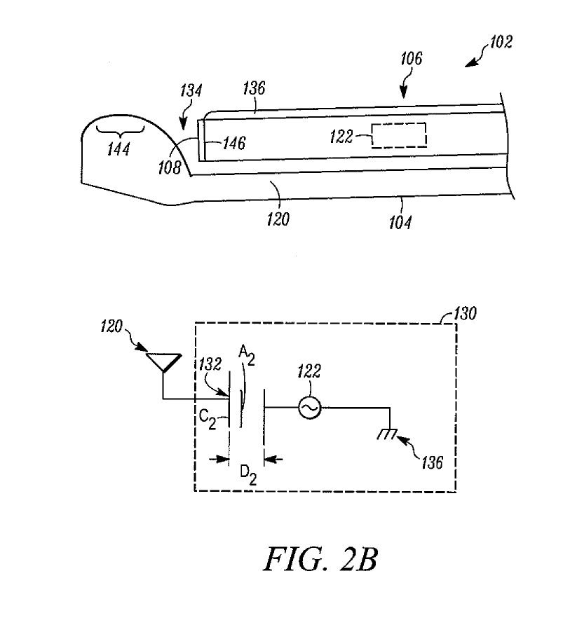

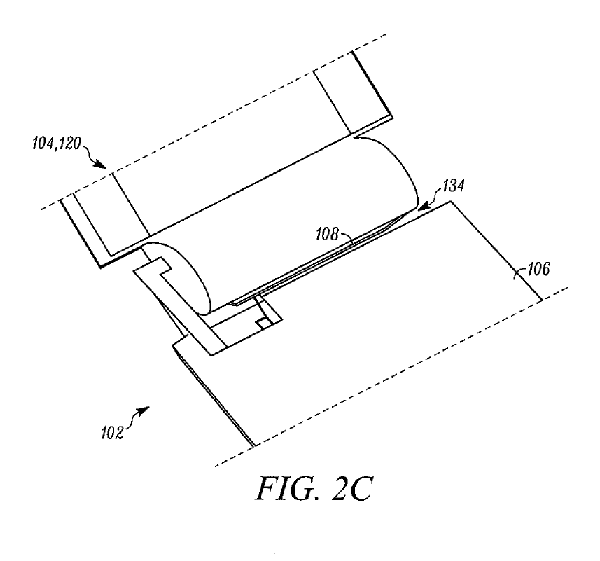

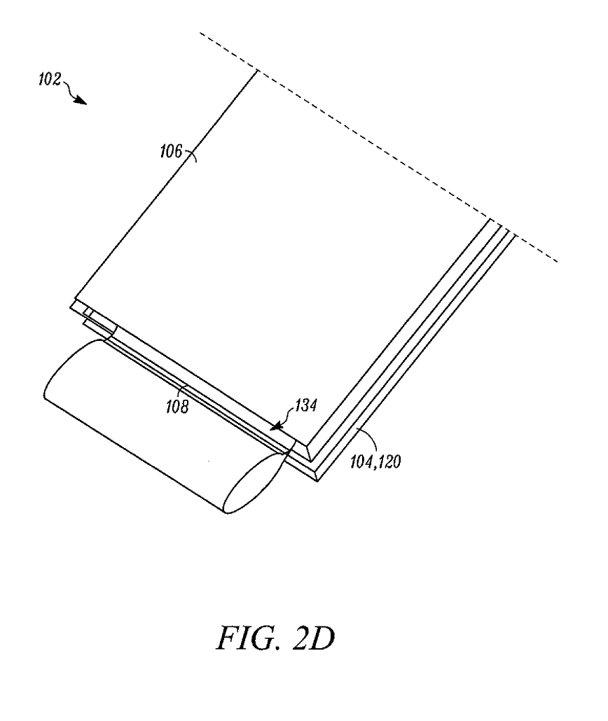

Turning to FIGS. 2A-2D, another embodiment of a clamshell-type cellular telephone 102 is shown in an open position (FIGS. 2A and 2C) and a closed position (FIGS. 2B and 2D). FIGS. 2A and 2B respectively show side elevation views of the cellular telephone 102 (with ends of the phone cutaway) in open and closed positions, respectively, while FIGS. 2C and 2D show additional perspective, cutaway views of the telephone. Again, the cellular telephone 102 includes an upper flip section 104 that is rotatably or hingedly coupled to a lower flip section 106 by way of a hinge-type mechanism shown as a hinge 108 (shown in phantom). FIGS. 2C and 2D show in more detail the hinge 108 of the cellular telephone 102 in particular. Also as previously described, the upper flip section 104 includes an antenna 120, which is formed from a metallic housing portion of the upper flip section, while the lower flip section 106 supports a transceiver 122 and serves as a ground 136 (particularly a metallic housing portion of the lower flip section).

As additionally shown in electrical schematic form particularly in FIGS. 2A and 2B, the cellular telephone 102 also is equipped with special transceiver circuitry 130. The transceiver circuitry 130 includes not only the transceiver 122 but also a variable capacitor 132, where the transceiver is coupled between the ground 136 and a first of the plates of the variable capacitor, and a second of the plates of the variable capacitor is coupled to (or formed as part of) the antenna 120 formed on the upper flip section 104. Capacitive coupling between the first and second plates of the variable capacitor 132 occurs by way of an air gap 134. The airgap may be filled with partially or fully with dielectric materials other than air.

In accordance with this embodiment, when the cellular telephone 102 is in the open position, the variable capacitor 132 has a first capacitance C₁, while when the cellular telephone is in the closed position, the variable capacitor has a second capacitance C₂. Thus, as with the cellular telephone 2 of FIGS. 1A and 1B, manual opening and closing of the cellular telephone 102 automatically switches an electrical characteristic of the circuitry 130 such that desired antenna operation is achieved regardless of whether the cellular telephone is open or closed.

Further, in the present embodiment, variation in the capacitance of the variable capacitor 132 is achieved by forming the capacitor plates directly as part of the upper and lower flip sections 104 and 106, and appropriately configuring the flip sections so that relative movement of the capacitor plates that occurs with movement of the flip sections during opening and closing of the cellular telephone 102 results in the desired capacitance variation. More particularly, in the present embodiment as shown in FIGS. 2A and 2B, the air-gap junction 134 exists between first and second neighboring portions 144 and 146 of the upper and lower flip sections 104, 106 of the cellular telephone, where the neighboring portions are metallic portions of the flip sections that can be understood as constituting the capacitor plates (or “feeding pads or plates”) of the variable capacitor 132. The first neighboring portion 144 of the upper flip section 104 in the present embodiment is merely the portion of the antenna 120 that is formed adjacent to the air-gap junction 134 and that is closest to the lower flip section 106.

The size of the air-gap junction 134 varies depending upon whether the cellular telephone 102 is open or closed, based upon the configuration of the hinge 108. More particularly, when the cellular telephone 102 is open as shown in FIG. 2A, the air-gap junction 134 is smaller and the capacitor plates formed by the first and second neighboring portions 144, 146 are relatively aligned. As illustrated in the electrical schematic diagram, the plates of the variable capacitor 132 thus can be presumed as being separated by an average distance D₁, and to overlap along an area A₁, thus resulting in the overall capacitance C₁. However, when the cellular telephone 102 is closed as shown in FIG. 2B such that the upper flip section 104 is adjacent to the lower flip section 106, and due to the relative shapes of the flip structures, the air-gap junction 134 increases in terms of the space separating the flip sections, and also the capacitor plates formed by the first and second neighboring portions 144, 146 are less well aligned. Thus, as illustrated in the electrical schematic diagram of FIG. 2B, the plates of the variable capacitor 132 can in this case be presumed to be separated by an average distance D₂, and to overlap along an area A₂, resulting in the overall capacitance C₂.

The shapes of the upper and lower flip sections 104, 106 and associated neighboring portions 144, 146 shown in FIGS. 2A and 2B are intended to illustrate how, given a particular hinge arrangement and particular shapes of those respective sections, the alignment of an air gap between the upper and lower sections can be made to vary considerably depending upon whether the cellular telephone 102 is opened or closed. At the same time, it should be understood that the particular physical configurations of the upper and lower flip sections (and associated neighboring portions or other structures) can be varied considerably depending upon the embodiment, as can the physical configurations of the hinge 108.

More particularly, in at least some alternate embodiments, the shapes of the flip sections 104, 106 (and associated neighboring portions 144, 146 or other structures) can be contoured differently to result in different capacitances as well as different manners of variation in capacitance, in order to achieve different tuning of the antenna or possibly other purposes. For example, in one alternate embodiment, the contours of the flip sections 104,106 can be reconfigured so that the flip open condition results in less capacitance (less area and distance) and the flip closed condition results in higher capacitance (more area and less distance). Also, in at least some embodiments, one or both of the upper and lower flip sections 104, 106 can include a protrusion or mechanical stop that limits movement of the sections with respect to one another (the stop could be part of one of the neighboring portions 144, 146). Such a mechanical stop could prevent further opening of the upper flip section 104 relative to the lower flip section 106 (e.g., beyond 175 degrees) and thereby limit variation in the operational characteristics of the antenna 120.

Additionally, from the above descriptions of FIGS. 1A, 1B, 2A and 2B, an overall method of operating a wireless communication device such as the cellular telephones 2, 102 is set forth. Namely, in an embodiment of a wireless communication device such as those described above having first and second structures that are hingedly coupled to one another, the wireless communication device can be first operated in a first mode such as that of FIG. 1A or 2A (or, alternatively, FIG. 1B or 2B), where first communication via an antenna of the device is governed by an electrical circuit having an electrical characteristic. Subsequently, however, a relative positioning of the first and second structures can be modified so as to produce a change in the electrical characteristic of the electrical circuit, so that the wireless communication device operates in a second mode such as that of FIG. 1B or 2B (or, alternatively, FIG. 1A or 2A). This process can be performed repeatedly as the first and second structures are opened, closed, reopened, etc.

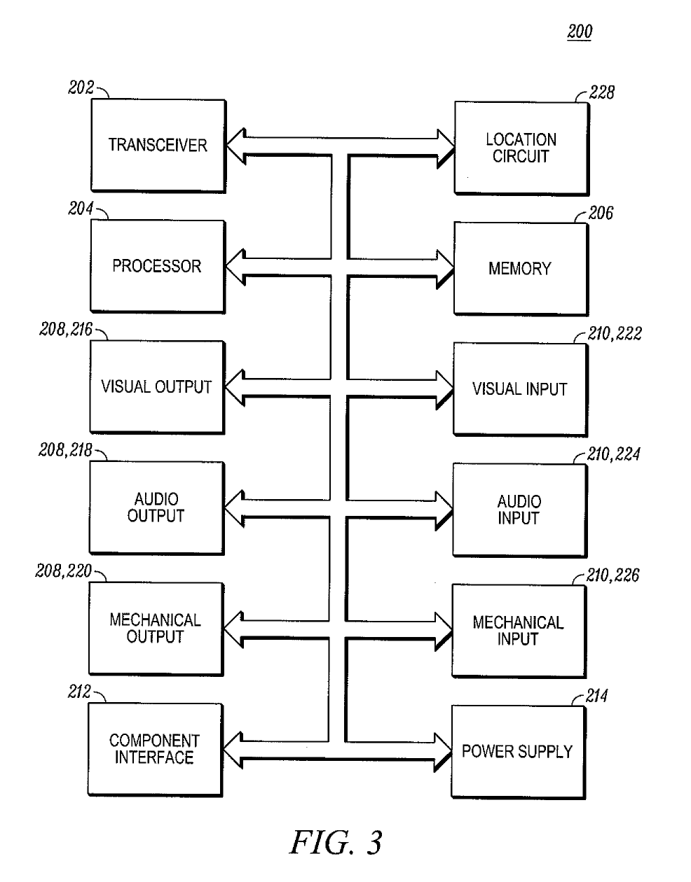

Turning to FIG. 3, there is provided a block diagram illustrating exemplary internal components 200 of the cellular telephone 2 of FIGS. 1A and 1B. Although particularly intended to be representative of the internal components of the cellular telephone 2, the block diagram is also representative of the internal components of other cellular telephones (e.g., the cellular telephone 102 of FIGS. 2A and 213), as well as other wireless or mobile devices, for example, personal digital assistants or personal computers capable of wireless communications. Also, while FIG. 3 shows the exemplary internal components 200, it should further be understood that these components are only intended to be exemplary and that the present invention is intended to encompass a wide variety of wireless communication devices that include other components in addition to those shown, and/or fail to include one or more of the components shown.

In the present embodiment the internal components 200 include a (or possibly more than one) wireless transceiver 202, a processor 204, a memory portion 206, one or more output devices 208, and one or more input devices 210. The processor 204 can be any of a variety of different processing devices including, for example, a microprocessor. In at least some embodiments, the internal components 200 include a user interface (not shown) that comprises the output and input devices 208 and 210. Notwithstanding the above discussion with respect to the other FIGS., the transceiver 202 shown in FIG. 3 for simplicity can be understood to include not only the transceiver 22 described above, but also the antenna 20 and transceiver circuitry 30. Also, the transceiver 202 typically utilizes wireless technology for communication, such as GSM technology, CDMA technology, UMTS technology, BlueTooth technology, etc. The internal components 200 can further include a component interface 212 to provide a direct connection to auxiliary components or accessories for additional or enhanced functionality. The internal components 200 preferably also include a power supply 214, such as a battery, for providing power to the other internal components while enabling the overall cellular telephone to be portable.

The internal components 200 can operate in conjunction with one another to perform a number of functions. For example, upon reception of wireless signals, the internal components 200 detect communication signals and the transceiver 202 demodulates the communication signals to recover incoming information, such as voice data and/or other data, transmitted by the wireless signals. After receiving the incoming information from the transceiver 202, the processor 204 formats the incoming information for the one or more output devices 208. Similarly, for transmission of wireless signals, the processor 204 formats outgoing information, which can (but need not) be activated by the input devices 210, and conveys the outgoing information to the transceiver 202 for modulation to communication signals. The transceiver 202 conveys the modulated signals to any of a variety of devices including, for example, devices that are relatively far away such as a cell tower or to devices that can be closer, such as a BlueTooth headset.

Further as shown in FIG. 3, the input and output devices 208, 210 of the internal components 200 can include a variety of types of visual, audio and/or mechanical input and output devices. For example, the output device(s) 208 can include a visual output device 216 such as a liquid crystal display or a light emitting diode indicator, an audio output device 218 such as a speaker, alarm and/or buzzer, and/or a mechanical output device 220 such as a vibrating mechanism. Likewise, by example, the input devices 210 can include a visual input device 222 such as an optical sensor (for example, a camera), an audio input device 224 such as a microphone, and a mechanical input device 226 such as a flip sensor, a keyboard, a keypad, a mouse, one or more selection buttons, a touch pad, a touch screen, a capacitive sensor, a motion sensor, and a switch.

Actions that actuate one or more of the input devices 210 can include, but are not limited to, opening (or closing) of the cellular telephone, unlocking the device, moving the device to actuate a motion, moving the device to actuate a location positioning system, pressing a button on the device, and operating the device. Additionally as shown in FIG. 2, the internal components 200 can also include a location circuit 228. Examples of the location circuit 228 include, but are not limited to, a Global Positioning System (GPS) receiver, a triangulation receiver, an accelerometer, a gyroscope, or any other information-collecting device that can identify a current location of the cellular telephone (or one or more of its internal components 200).

The memory portion 206 of the internal components 200 can include any number of a variety of different types of memory devices such as random access memory (RAM) devices, and can be used to store and retrieve data. Typically, although not necessarily, operation of the memory portion 206 in storing and retrieving data is governed by commands from the processor 204. The data that is stored by the memory portion 206 can include, but need not be limited to, operating systems (or other systems software), applications, and data. Each operating system in particular includes executable code that controls basic functions of the cellular telephone, such as interaction among the various internal components 200, communication with external devices via the transceiver 202 and/or the component interface 212, and storage and retrieval of applications and data to and from the memory portion 216.

As for the applications, each application includes executable code that operates in conjunction with the operating system to provide more specific functionality for the cellular telephone, such as file system service and handling of protected and unprotected data stored in the memory portion 216. Exemplary applications can include, for example, a discovery application for discovering media on behalf of a user and his/her phone and a download user agent responsible for downloading the media object described by the download descriptor. As for the data, data is non-executable code or information that can be referenced and/or manipulated by an operating system or application for performing functions of the cellular telephone 2.

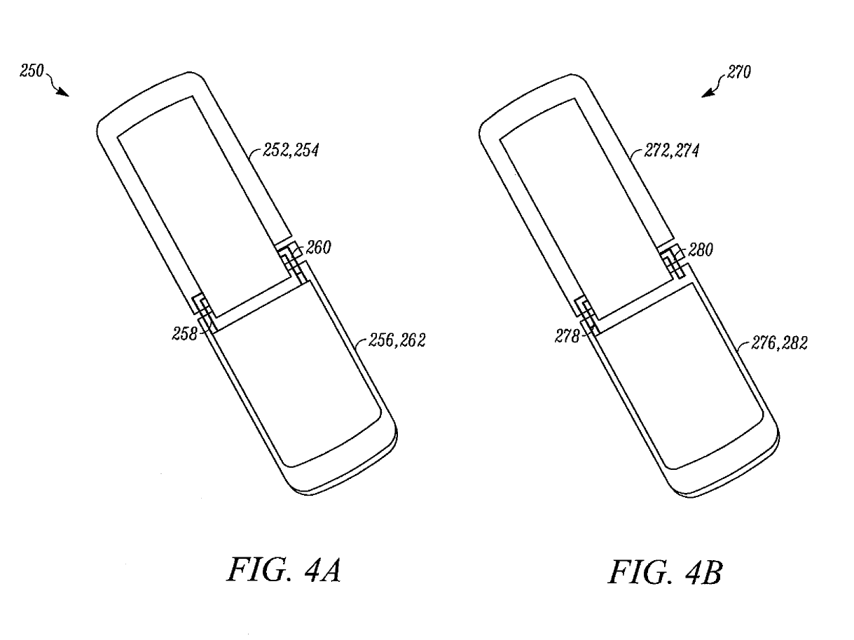

Notwithstanding the description provided above in relation to certain embodiments of the invention shown in FIGS. 1A-3, the present invention is intended to encompass a variety of other embodiments and configurations as well. For example, referring to FIGS. 4A and 4B, two alternate embodiments of cellular telephones 250 and 270 are shown. As with the cellular telephones 2 and 102 described above, the cellular telephones 250, 270 each have a respective upper flip section 254, 274 coupled to a respective lower flip section 256, 276 by way of a respective hinge 258, 278. However, in the cellular telephone 250, an antenna 252 of the upper flip section 254 is coupled to a ground 262 provided by the lower flip section 256 by coupling the upper and lower flip sections inductively by way of an inductor 260, which is a direct ground connection. As for the cellular telephone 270, an antenna 272 of the upper flip section 274 is coupled to a ground 282 of the lower flip section 276 by way of a capacitive ground coupling 280 (e.g., an overlapping ground connection that does not touch but forms capacitance). The inductor 260 or capacitive ground coupling 280 of FIGS. 4A and 4B can enhance the performance (bandwidth and efficiency) of the respective antennas 252, 272, particularly for various frequencies of operation.

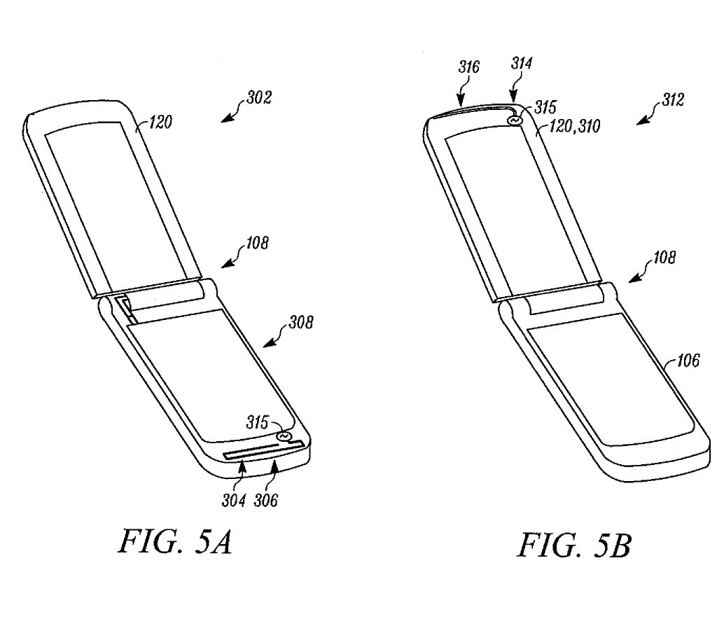

Turning additionally to FIGS. 5A and 5B, in further alternate embodiments of the invention, arrangements such as those shown in FIGS. 1A-4B can be employed in combination with an additional antenna, which can be a conventional or traditional antenna that takes up specific amounts of volume within the device. For example, FIG. 5A shows a cellular telephone 302 that is identical to the cellular telephone 102 of FIGS. 2A-2D except insofar as, in addition to including the antenna 120, the telephone also includes a further antenna element 304 mounted at (or within) a bottom portion 306 of a lower flip section 308 of the phone. Additionally for example, FIG. 5B shows a cellular telephone 312 that is identical to the cellular telephone 102 of FIGS. 2A-2D except insofar as, in addition to including the antenna 120, the telephone also includes a further antenna element 314 mounted at (or within) a top portion 316 of an upper flip section 310 of the phone. Depending upon the embodiment, the further antenna elements 304, 314 can be operated independently of the antenna 120 or operated in conjunction therewith (e.g., coupled thereto by a link via the hinge 108). For purposes of the present exemplary embodiments, the antenna elements 304, 314 are shown to be driven by a transceiver signal 315 that differs from that provided by the transceiver 122 discussed above (although in other embodiments, the signal could be the same).

In still additional embodiments, further antenna elements can be included on both the bottom or top portions 306, 316 or in other locations, e.g., along the sides of the upper and/or lower flip sections. A variety of antenna schemes can be employed depending upon the embodiment including, for example, monopole antennas, Inverted F antennas (IFA), Planar Inverted F antennas (PIFA), or slot antennas. Indeed, while the embodiments of FIGS. 1A-2D envision the use of a single antenna formed from a single metallic portion on one or the other of the upper and lower flip sections, the present invention is intended to encompass a wide variety of different devices having any number of antennas or antenna-type structures on one or both of the upper and lower flip sections (and even possibly on the hinges) of the devices.

Additionally, while the embodiments described above with respect to FIGS. 1A-2D show transceiver circuitry that is varied in terms of its matching characteristics or capacitance in particular, other embodiments are also possible. For example, in some embodiments, different inductors (e.g., chosen by an RF switch) could be used to obtain appropriate matching and could be varied depending upon the open or closed status of the cellular telephone or other wireless communication device. Further, although the embodiments discussed above with respect to FIGS. 1A-5B concern clamshell-type cellular telephones, the present invention is also intended to be applicable to a variety of other wireless communication devices, and in particular is intended to be applicable to a variety of wireless communication devices that have hinged components such as notebook/laptop computers and the like.

It is specifically intended that the present invention not be limited to the embodiments and illustrations contained herein, but include modified forms of those embodiments including portions of the embodiments and combinations of elements of different embodiments as come within the scope of the following claims.

We claim:

1. A wireless communication device comprising:
a first structure;
a second structure that is hingedly coupled to the first structure, wherein at least a part of at least one of the first and second structures is capable of operating as an antenna, and
an electrical circuit at least partially governing operation of the antenna, wherein the electrical circuit is supported at least indirectly by at least one of the first and second structures,
wherein at least one electrical characteristic of the electrical circuit varies depending upon a relative positioning of the first structure with respect to the second structure.

2. The wireless communication device of claim 1, wherein the first and second structures are first and second outer housing portions.

3. The wireless communication device of claim 2, wherein the device is one of a cellular telephone and a personal computer.

4. The wireless communication device of claim 3, wherein the device is a cellular telephone, and the first and second outer housing portions are capable of opening with respect to one another in a clamshell-like manner.

5. The wireless communication device of 2, wherein the first structure is metallic and serves as the antenna, and further comprising an additional antenna coupled to one of the first and second structures

6. The wireless communication device of claim 1, wherein the electrical circuit includes matching circuitry that serves to at least partly match the antenna.

7. The wireless communication device of claim 6, wherein the matching circuitry provides a first matching impedance when the first and second structures are in an opened position relative to one another, and provides a second matching impedance when the first and second structures are in a closed position relative to one another.

8. The wireless communication device of claim 7, wherein when in the opened position the first structure is oriented within a first angular range of 160 degrees to 175 degrees relative to the second structure, and when in the closed position the first structure is oriented within a second angular range of 0 degrees to 15 degrees relative to the second structure.

9. The wireless communication device of claim 6, wherein the matching circuitry includes first and second matching circuits, and wherein the electrical circuit includes first and second contacts that are respectively coupled in series with the first and second matching circuits, respectively, between a transceiver and the antenna.

10. The wireless communication device of claim 9, wherein the first contact is closed and the second contact is open when the relative positioning of the first and second structures is an open positioning, and wherein the first contact is open and the second contact is closed when the relative positioning of the first and second structures is a closed positioning.

11. The wireless communication device of claim 1, wherein the electrical circuit includes a capacitance that varies depending upon the relative positioning.

12. The wireless communication device of claim 11, wherein the capacitance is formed between a first portion of the first structure and a second portion of the second structure.

13. The wireless communication device of claim 12, wherein variation of the capacitance is due to at least one of a first change in a spacing between the first and second portions of the first and second structures, respectively, and a second change in first and second areas of the first and second portions, respectively, that overlap.

14. The wireless communication device of claim 1, wherein at least one of the first and second structures includes a mechanical stop that limits an extent to which the first structure can be opened relative to the second structure.

15. The wireless communication device of claim 1, wherein at least one of the following is true:
(a) the first and second structures are connected by a hinge structure through which at least one wire connection passes, the wire connection allowing for communication of a signal between the first and second structures; and
(b) a grounding connection is provided between the first and second structures by way of at least one of an inductive coupling structure and a capacitive coupling structure.

16. A cellular telephone comprising:
a top housing portion;
a bottom housing portion, wherein at least one of the top and bottom housing portions operates as an antenna;
an electrical circuit coupled to the antenna; and
means for rotatably coupling the top and bottom housing portions,
wherein an electrical characteristic of the electrical circuit varies based upon a change in a relative positioning of the top and bottom housing portions.

17. The cellular telephone of claim 16, wherein the electrical circuit includes at least one contact that opens or closes based upon the relative positioning, and wherein the relative positioning causes an electrical circuit portion of the electrical circuit to be switched into or out of communication with the antenna due to opening or closing of the at least one contact.

18. The cellular telephone of claim 16, wherein first and second capacitor plate sections are formed on the top and bottom housing portions, and wherein the change in the relative positioning of the top and bottom housing portions causes an additional change in an additional relative positioning of the first and second capacitor plate sections, thus resulting in a variation in a capacitance.

19. A method of operating a wireless communication device, the method comprising:
providing first and second structures that are hingedly coupled to one another;
operating the device in a first mode, wherein first communication via a first antenna of the device is governed by an electrical circuit having an electrical characteristic;
varying a first position of the first structure in relation to a second position of the second structure, wherein the varying results in a change in the electrical characteristic of the electrical circuit; and
operating the device in a second mode, wherein second communication via at least one of the first antenna and a second antenna of the device is governed by the electrical circuit having the changed electrical characteristic.

20. The method of claim 19, wherein the second communication is via the first antenna, wherein the first antenna is formed on part of at least one of the first and second structures, and wherein the change in the electrical characteristic involves one of a first change in a matching circuit portion of the electrical circuit, a second change in a capacitance of the electrical circuit, and a third change in an inductance of the electrical circuit.
